(19) United States
(12) Patent Application Publication
(10) Pub. No.: US 2005/0034802 A1
(43) Pub. Date: Feb. 17, 2005

(54) Production method for unvulcanized rubber member and tire

(76) Inventors: Jingo Shirasaka, Tokyo (JP); Tsuguyoshi Yamada, Tokyo (JP); Ichiro Wada, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/495,336

(22) PCT Filed: Oct. 24, 2002
(86) PCT No.: PCT/JP02/11048

(30) Foreign Application Priority Data
Nov. 12, 2001 (JP) 2001-345540
Dec. 26, 2001 (JP) 2001-394728

(51) Int. Cl. B60C 1/00

(52) U.S. Cl. 152/564

(57) ABSTRACT

A method of producing an uncured rubber member by separately producing a rubber composition A of a compounding system excluding a vulcanizing agent and a rubber composition B of a compounding system excluding a vulcanization accelerator and shaping the rubber compositions A and B into given forms through a shaping machine and winding on a rotating support does not cause the scorching at the shaping step and is high in the shaping efficiency. Also, the durability and the internal pressure holding property at a run-flat state are simultaneously established in a tire provided with an innerliner in which a rubber component for the innerliner contains at least 10% by mass of diene rubber in a region corresponding to a tire side portion and a ratio of diene rubber in a region corresponding to a tire tread portion is made lower than that in a side portion corresponding region.

### TECHNICAL FIELD

This invention relates to a process and an apparatus for producing an uncured rubber member as well as a tire and a method of producing the same, and more particularly to a process and an apparatus for producing an uncured rubber member in which two or more kinds of uncured rubber compositions are separately extruded and wound on a rotating support as well as a run-flat tire capable of safely running even if an air pressure of the tire drops and a method of producing the same.

### BACKGROUND ART

In general, a composite having various rubbers is required to take such a step that various uncured rubber members are stuck before vulcanization in the production of the composite. When the composite is a pneumatic tire (hereinafter referred to as a tire), the tire is comprised of reinforcing members such as organic fiber or steel cords and various rubber members. Therefore, an uncured tire formed by sticking uncured rubber members and reinforcing members such as cords and the like is provided at a shaping step before the vulcanization of tire.

At present, performances required for the rubber composites inclusive of the tires tend to be more upgraded and diversified. For this end, the shaping step becomes naturally complicated and it is actual state that manual operation is still required. However, as the manual operation gets into the shaping step, a big improvement of a shaping efficiency can not be attained, and also there is a problem that a sticking accuracy of various members lowers. In case of the tire, the improvement of the sticking accuracy is strongly demanded in addition to the improvement of the shaping efficiency because the good or bad sticking accuracy particularly controls the quality of the tire.

In order to meet the above demand, JP-B-7-94155 proposes a process and an apparatus wherein an outlet orifice of a constant delivery extruder is located in the vicinity of a position for arranging a rubber member on a rotating support and a rubber composition is directly extruded from the constant delivery extruder through the outlet orifice onto the support. Also, JP-A-2000-79643 proposes a process and an apparatus wherein plural rubber compositions are directly extruded onto the support through a single extruding device with mixing.

In the extrusion methods described in the above publications, however, if the extrusion rate is made faster for increasing the shaping efficiency, there is a problem of largely fearing that the heat build-up of the rubber composition is caused by friction in the extruder to cause scorching (phenomenon of causing vulcanization at an unanticipated time). On the contrary, if it is intended to reduce the friction in the extruder by making the extrusion rate slow, there is a problem of lowering the shaping efficiency. Therefore, these methods are not an effective solution means.

Further, when the vulcanization rate is made slow by selecting the kind of vulcanization accelerator or by decreasing amounts of vulcanizing agent (sulfur) and vulcanization accelerator, the scorching hardly occurs, but there is a problem that it is required to prolong the vulcanization time.

On the other hand, the safety of the tire is put importance on, and as a result, there are demanded run-flat tires capable of running even when the internal pressure is dropped due to foreign matters such as nail and the like or any cause. In this connection, there are proposed the insertion of a filler body or a core cylinder into an inside of the tire, the use of a side reinforcing rubber as described in JP-A-4-185512 and so on.

As one drawback in the above side-reinforced type run-flat tire, the bending of the side portion in the running of the tire after the drop of the internal pressure becomes fairly large as compared with that in the presence of the internal pressure and rubber peeling is caused between rubbers. Because, an innerliner is made of only butyl rubber or a halogenated butyl rubber and the side reinforcing rubber is mainly composed of a diene-based rubber and hence an adhesion force therebetween is insufficient. There is a fear that the side reinforcing rubber is further broken accompanied with the rubber peeling to make the running impossible.

When the innerliner is made of a diene rubber for preventing the rubber peeling, since the diene rubber is low in the ability of preventing air permeation, there is an unfavorable problem that air impermeability inherent to the innerliner lowers.

When the side reinforcing rubber is butyl rubber, the peeling is caused between the carcass ply and the side reinforcing rubber but also the durability comes into problem because the heat build-up of the butyl rubber is large.

When natural rubber is co-used in the innerliner composed mainly of butyl rubber or halogenated butyl rubber, the adhesion force to the other member made of diene-based rubber is improved, but there is a problem that an internal pressure holding property largely lowers due to the presence of the natural rubber being low in the ability of preventing air permeation because the innerliner is formed with a sheet-like rubber having a single composition in the conventional drum shaping.

### DISCLOSURE OF THE INVENTION

It is a first object of the invention to provide a process and an apparatus for producing an uncured rubber member without causing the scorching at a shaping step and in a high building efficiency.

It is a second object of the invention to provide a tire establishing a durability at a run-flat state and an internal pressure holding property and a method of producing the same.

Means for achieving the first object are as follows:
(1) A process for producing an uncured rubber member, which comprises separately preparing a rubber composition A of a compounding system excluding a vulcanizing agent and a rubber composition B of a compounding system excluding a vulcanization accelerator, and shaping the rubber composition A and the rubber composition B into respective desired forms in a shaping machine to wind on a rotating support.
(2) A process for producing an uncured rubber member according to the item (1), wherein said shaping machine is an extruder.
(3) A process for producing an uncured rubber member according to the item (1) or (2), wherein the form of the rubber composition A and/or B after the shaping is any one of a sheet, a ribbon and a string.
(4) A process for producing an uncured rubber member according to any one of the items (1) to (3), wherein the rubber composition A and/or B after the shaping is helically wound.
(5) A process for producing an uncured rubber member according to any one of the items (1) to (4), wherein the rubber compositions A and B are cooled before the winding on the rotating support.
(6) A process for producing an uncured rubber member according to any one of the items (1) to (5), wherein an existing ratio of the rubber composition A to the rubber composition B in the uncured rubber member is adequately changed.
(7) A process for producing an uncured rubber member according to any one of the items (1) to (5), wherein an existing ratio of the rubber composition A to the rubber composition B in the uncured rubber member is adequately changed in a widthwise direction of the support.
(8) An apparatus for producing an uncured rubber member comprising a rotating support and plural extruders communicating with the support.
(9) An apparatus for producing an uncured rubber member according to the item (8), which further comprises a cooling device between the extruder and the support.

Means for achieving the second object are as follows.
(10) A tire provided with an innerliner, characterized in that a rubber component in the innerliner contains at least 10% by mass of a diene rubber in a portion corresponding to a side portion of the tire and a ratio of the diene rubber is lower in a portion corresponding to a tread portion of the tire than that in the portion corresponding to the side portion.
(11) A tire according to the item (10), wherein the rubber component of the innerliner contains 10-40% by mass of the diene rubber in the portion corresponding to the side portion of the tire.
(12) A tire according to the item (10) or (11), wherein the rubber component of the innerliner is composed mainly of a halogenated butyl rubber and contains 90-60% by mass of the halogenated butyl rubber and 10-40% by mass of the diene rubber.
(13) A tire according to any one of the items (10) to (12), wherein the diene rubber is natural rubber.
(14) A tire according to any one of the items (10) to (13), wherein a reinforcing rubber of substantially a crescent-shaped section is arranged between an innerliner and a carcass ply in the side portion of the tire.
(15) A tire according to the item (10) or (11), wherein a ratio of the diene rubber in the rubber component of the innerliner is continuously changed in a region ranging from the portion corresponding to the side portion of the tire to the portion corresponding to the tread portion of the tire.
(16) A method of producing a tire provided with an innerliner by taking out different rubber compositions from plural storing tanks each containing the respective rubber composition, extruding through an extruder while kneading them and winding the resulting extrudate on a rotating support to form an innerliner layer for the tire, characterized in that take-out amounts of these rubber compositions are changed so that a rubber component in the innerliner contains at least 10% by mass of a diene rubber in a portion corresponding to a side portion of the tire and a ratio of the diene rubber is lower in a portion corresponding to a tread portion of the tire than that in the portion corresponding to the side portion.
(17) A method of producing a tire according to the item (16), wherein the take-out amounts are continuously changed.
(18) A method of producing a tire according to the item (16) or (17), wherein the rotating support is a rigid core having an outer face shape substantially corresponding to an inner face shape of a product tire.

### BRIEF DESCRIPTION OF THE DRAWINGS

FIG. 1 is a partial section view illustrating a winding state of a rubber composition in the production process of an uncured rubber member according to the invention.

FIG. 2 is a schematic view of a production apparatus according to the invention.

FIG. 3 is a schematically side view of an apparatus of producing a tire in the production method of the tire according to the invention.

### BEST MODE FOR CARRYING OUT THE INVENTION

[Process and Apparatus for Producing an Uncured Rubber Member]

The process and apparatus for producing the uncured rubber member according to the invention will be described in detail below. Heretofore, the uncured rubber composition contains a reinforcing agent, a softening agent, an activator, an antioxidant, a work-improving agent, a vulcanizing agent and a vulcanization accelerator in addition to a starting rubber. After the uncured rubber composition is shaped into a desired form, or after the uncured rubber composition after the shaping is stuck on a reinforcing material such as cords or the like to form an uncured rubber member, the uncured rubber composition is vulcanized by heating to form a member having a sufficient strength. Therefore, if heat is applied to the uncured rubber composition by friction or the like at, for example, a shaping step before the vulcanization step, since the composition contains the vulcanizing agent and vulcanization accelerator, there is a possibility of causing the unanticipated scorching.

On the contrary, in the production process of the uncured rubber member according to the invention are separately prepared a rubber composition A obtained by excluding the vulcanizing agent from the above conventional compounding system and a rubber composition B obtained by excluding the vulcanization accelerator from the above conventional compounding system. Therefore, the rubber composition A and the rubber composition B do not contain either the vulcanizing agent or the vulcanization accelerator, respectively, so that the scorching is not caused at the shaping step even if heat is generated by friction.

In the production process of the uncured rubber member according to the invention, SBR, NR, BR, butyl rubber and the like are mentioned as a starting rubber used in the rubber composition. These starting rubbers may be used alone or in a blend of two or more. As the reinforcing agent are mentioned carbon black, silica and the like. As the vulcanizing agent, vulcanization accelerator and other additives, use may be made of any substances usually used in a rubber industry. Since thiurams among the vulcanization accelerators are vulcanizable alone, however, they are excluded from the application to the rubber compositions A and B.

When the uncured rubber member is produced by using the rubber composition of the aforementioned conventional compounding system, once the scorching is caused in the shaping machine, there are problems that the shaping machine should be disassembled to clean up the inside of the machine but also the scorching may be a cause on the trouble of the machine. On the contrary, according to the invention, there are provided plural shaping machines, and rubber compositions each being not vulcanizable, i.e. a rubber composition A of a compounding system excluding a vulcanizing agent and a rubber composition B of a compounding system excluding a vulcanization accelerator are separately fed to the shaping machine and extruded therefrom, so that even if heat is generated by friction in the shaping machine, the occurrence of the scorching can be avoided, and hence the conventional problems such as disassembling and cleaning of the machine due to the occurrence of the scorching and troubles of the machine can be solved.

In the production method of the uncured rubber member according to the invention, the occurrence of the scorching can be prevented as mentioned above, so that it is possible to shape these rubber compositions A and B from the plural shaping machines at extrusion rates sufficient to their machine capacities and the production efficiency in the shaping can be largely improved. Also, it is not required to take means for decreasing the compounding amounts of the vulcanizing agent and the vulcanization accelerator, so that there is not caused a problem of taking a long vulcanization time.

In the production method of the uncured rubber member according to the invention, the rubber composition A and the rubber composition B are shaped separately and wound on the support, so that the thus shaped uncured rubber members are rendered into a rubber composition curable in the subsequent vulcanization step. Therefore, it is possible to vulcanize both the rubber compositions as the thermal diffusion of the vulcanizing agent/vulcanization accelerator is produced by heating at the vulcanization step.

In order to conduct the sufficient thermal diffusion, it is preferable that each of the rubber compositions A and B contains an amount of the vulcanizing agent or the vulcanization accelerator sufficient to compensate for its primary compounding. Particularly, it is preferable that the rubber composition A contains a double amount of the vulcanization accelerator, while the rubber composition B contains a double amount of the vulcanizing agent.

Considering the thermal diffusion distance of the vulcanizing agent/vulcanization accelerator, the thickness of the shaped body of each rubber composition is preferable to be not more than 2 mm. And also, it is difficult to completely overlap these rubber compositions with each other in the winding, but the overlapping shift is preferable to be not more than 2 mm because there is no problem unless the above shift is within a range of conducting the thermal diffusion of the vulcanizing agent/vulcanization accelerator.

Since the crosslinkable rubber compositions are formed by the thermal diffusion of the vulcanizing agent/vulcanization accelerator at the vulcanization step in the production method of the uncured rubber member according to the invention, if the shaped bodies of the two rubber compositions are contacted at a fairly higher temperature state just after the extrusion through the shaping machine, the thermal diffusion of the vulcanizing agent/vulcanization accelerator is caused and hence there is a fear of starting vulcanization (crosslinking). For this end, it is preferable that the shaped body of the rubber composition is rapidly cooled to about 90° C., preferably not higher than 70° C. before the winding of the shaped body onto the support.

In the production method of the uncured rubber member according to the invention, after the rubber compositions are extruded and shaped through the shaping machine such as an extruder or the like, the shaped bodies of these rubber compositions are wound on the support. In this case, the form of the rubber composition after the shaping is not particularly restricted unless it can be made into the desired form, and may be any one of sheet, ribbon, string and the like.

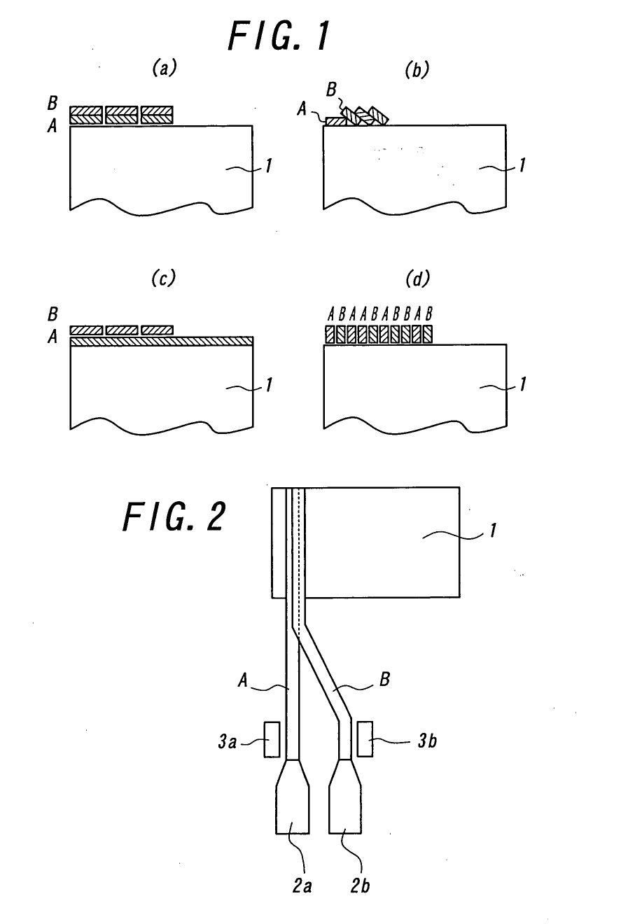

As the winding method, the helical winding is preferable, but is not limited in accordance with the form of the shaped body. For example, there are helical winding of flat-shaped laminate as shown in FIG. 1(a), helical slant winding as shown in FIG. 1(b), helical winding of a ribbon-shaped body on a sheet-shaped body as shown in FIG. 1(c), helical winding of shaped bodies laminated vertically to an outer peripheral face of the support, and the like.

As the shaping machine used for extruding the rubber composition in the production method of the uncured rubber member according to the invention, mention may be made of an extruder and the like. By using plural shaping machines can be separately wound the rubber composition A and the rubber composition B on the support.

In the production method of the uncured rubber member according to the invention, the existing ratio of the rubber compositions A and B in the uncured rubber member made of these rubber compositions can be properly changed in the uncured rubber member. As the changing method, there are a method of changing a thickness ratio of the shaped bodies of the rubber compositions A and B, a method of changing the winding number of either shaped body and the like.

Further, in the production method of the uncured rubber member according to the invention, the existing ratio of the rubber compositions A and B in the uncured rubber member can be properly changed viewing from the widthwise direction of the support. Such a changing can be realized, for example, by properly forming a dense portion of the rubber composition A or B and a loose portion of the rubber composition A or B as shown in FIG. 1(d).

Next, an embodiment of the apparatus for producing the uncured rubber member according to the invention is explained in detail with reference to FIG. 2. In FIG. 2, a support 1 is attached to a shaft rotating through the driving of a rotation driving source omitted in illustration. The support 1 is a shaping drum, a last-off shaped body made by winding a part of uncured rubber members, cords coated with an uncured rubber and the like on the shaping drum, a base tire for retreading or the like.

The apparatus according to the invention is provided with plural extruders, two extruders 2a, 2b in the embodiment of FIG. 2. The rubber composition A is extruded through the extruder 2a and the rubber composition B is extruded through the extruder 2b, and the shaped bodies A and B thereof are wound on the support 1.

In this case, if the two shaped bodies A and B of the rubber compositions contact with each other at a fairly higher temperature state just after the extrusion as previously mentioned, there is a fear that the thermal diffusion of vulcanizing agent/vulcanization accelerator is caused to start the vulcanization, so that it is preferable to provide cooling devices 3a and 3b for rapidly cooling the shaped bodies A and B of the rubber compositions extruded through the extruders to about 90° C., preferably not higher than 70° C. before the winding of these shaped bodies on the support 1. The cooling devices 3a and 3b are disposed between the extruders 2a and 2b and the support 1.

[Tire and Production Method Thereof]

The tire and the production method thereof according to the invention are described in detail below. In the tire provided with an innerliner according to the invention, the rubber component of the innerliner contains a diene rubber of at least 10% by mass, preferably 10-40% by mass, more preferably 10-35% by mass at a region corresponding to a tire side portion. Therefore, the innerliner becomes higher in the adhesion force to the side portion mainly composed of a diene rubber as compared with the conventional innerliner comprising only a butyl rubber or a halogenated butyl rubber as the rubber component. In the tire according to the invention, air or an inert gas such as nitrogen or the like is mentioned as a gas to be filled in the tire.

On the other hand, the rubber component of the innerliner at a region corresponding to a tire tread portion is low in the ratio of diene rubber as compared with the side portion corresponding region. Since the tread portion corresponding region is not so subjected to bending even in the running at a run-flat state, the internal pressure holding property inherent to the innerliner itself can be enhanced by applying a rubber component having the ratio of diene rubber lower than that of the side portion corresponding region (rubber component having a higher ratio of butyl rubber or halogenated butyl rubber).

Also, the innerliner in the tire according to the invention is preferable to be composed mainly of a halogenated butyl rubber and to contain 90-60% by mass of the halogenated butyl rubber and 10-40% by mass of the diene rubber from a viewpoint of establishing the durability and the internal pressure holding property at the run-flat state.

As the diene rubber used in the innerliner are mentioned natural rubber and synthetic diene rubbers, and among them natural rubber is preferable. As the halogenated butyl rubber are a brominated butyl rubber and the like. The innerliner may be compounded with compounding agents and the like usually used in the innerliner composition in the tire industry in addition to the above diene rubber and halogenated butyl rubber.

Preferably, the tire according to the invention is a run-flat tire. The run-flat tire according to the invention is characterized by disposing a reinforcing rubber of substantially a crescent-shaped form at its section between the innerliner and the carcass ply in the tire side portion.

In the innerliner of the tire according to the invention, it is preferable that the ratio of diene rubber in the component for the innerliner is continuously changed from the side portion corresponding region to the tread portion corresponding region. Also, the thickness of the innerliner may be continuously changed from the side portion corresponding region to the tread portion corresponding region. In the innerliner, the high ratio of butyl rubber or halogenated butyl rubber and the large thickness improve the internal pressure holding property, but become disadvantageous in the cost. However, when the rubber component/thickness in the innerliner are continuously changed in the widthwise direction of the tire, it is possible to attain an optimum arrangement of the rubber component in view of performances/cost.

In the conventional drum shaping, it is considered that it is at least possible to obtain the innerliner of the above construction by using a division body consisting of rubber component compositions for the regions corresponding to the side portion and the tread portion in the application of the innerliner. However, the drum shaping is required to take a manual operation as pointed out from the old time, so that the large improvement of the shaping efficiency can not be attained and also there is a problem of lowering the application accuracy. On the contrary, the problems in such a drum shaping can be solved by adopting the production method of the tire according to the invention.

In the production method of the tire according to the invention, two or more different rubber compositions are separately taken out from plural storage tanks including these rubber compositions and kneaded and extruded through an extruder and then the extrudate is wound on a rotating support to form an innerliner for the tire, in which take-out amounts of these rubber compositions are changed so that a rubber component in the innerliner contains at least 10% by mass of a diene rubber in a portion corresponding to a side portion of the tire and a ratio of the diene rubber is lower in a portion corresponding to a tread portion of the tire than that in the portion corresponding to the side portion.

In this case, the ratio of diene rubber in the same innerliner can be continuously changed by continuously changing the take-out amounts of different rubber compositions taken out from the plural storage tanks. For instance, the ratio of diene rubber in the rubber component for the innerliner can be continuously changed from the side portion corresponding region to the tread portion corresponding region.

When the production method of the tire according to the invention is adopted, it is easy to optionally change the ratio of diene rubber between the side portion corresponding region and the tread portion corresponding region in the innerliner, and the manual operation is not required, so that the productivity can be increased. Also, it is easily possible to optionally change the thickness by the production method of the tire according to the invention.

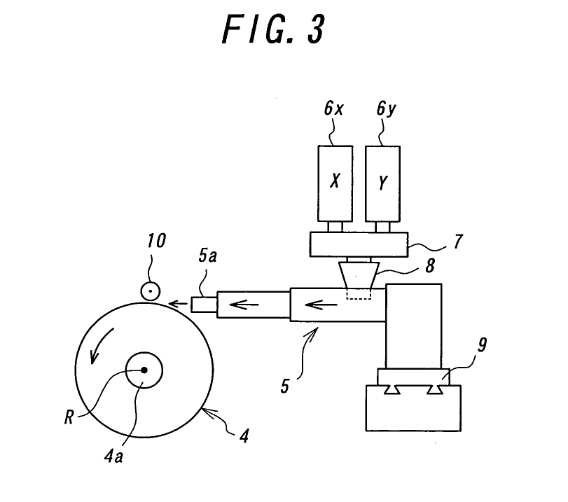

Next, an embodiment of the invention is explained in detail with reference to FIG. 3. In FIG. 3 is shown an outline side view of a production apparatus attaining the production method of the tire according to the invention. In FIG. 3, a support 4 is attached to a shaft 4a rotating through the driving of a rotation driving source omitted in its illustration. The support 4 is a rigid core for shaping a green tire. Moreover, the rigid core for shaping the green tire has an outer face form substantially corresponding to an inner face form of a product tire. The support 4 has a winding face of a rubber member on its surface.

An extruder 5 is arranged so as to locate a rubber member feeding port 5a of the extruder 5 in the vicinity of the surface of the support 4. Moreover, the production apparatus shown in FIG. 3 is a combined apparatus of the support 4 and the extruder 5. The feeding port 5a includes both a case providing a usual extrusion orifice and a case that a pair of up and down roller dies is provided instead of the extrusion orifice. As a form of a rubber member extruded from the feeding port 5a are mentioned a ribbon, a string and the like.

The extruder 5 is provided with two or more storage tanks, two storage tanks 6x, 6y in the illustrated embodiment separately storing uncured rubber compositions X and Y. Also, the storage tanks 6x, 6y are provided with a rubber composition feeding device 7 separately adjusting the feeding amounts of the rubber compositions X and Y. The rubber compositions X and Y passed through the rubber composition feeding device 7 are charged into a main body of the extruder 5 through a hopper or a feeder 8.

In the production method of the tire according to the invention, the rubber compositions having different ratios of diene rubber and halogenated butyl rubber, for example, rubber composition X containing 100% by mass of halogenated butyl rubber as a rubber component and rubber composition Y containing 75% by mass of halogenated butyl rubber and 25% by mass of diene rubber as a rubber component are separately charged into the storage tanks 6x and 6y, and the feeding amount of each rubber composition is controlled by the rubber composition feeding device 7 in accordance with the regions of the innerliner to be produced. The extruder of the illustrated embodiment is provided with the two storage tanks, but the number of the storage tanks is not limited thereto and the object of the invention can be achieved unless the number of the storage tanks is two or more.

Further, the extruder 5 is provided with a control means controlling the charging time, charging stop time and flowing amount of each rubber composition through the rubber composition feeding device 7 in accordance with the exchange of the support or the regions of the innerliner to be produced. Thus, the rubber composition used can be changed, for example, in the tread portion corresponding region and the side portion corresponding region of the innerliner. Further, the ratio of diene rubber can be continuously changed from the side portion corresponding region to the tread portion corresponding region by continuously changing the take-out amount of each rubber composition in the formation of the one innerliner.

And also, the extruder 5 is provided with a linear moving mechanism 9. The linear moving mechanism 9 linearly moves the extruder 5 along a central axis R of a rotating shaft 4a of the support 4. This movement is to successively wind the rubber member fed from the feeding port 5a onto the winding face of the support in a helical form. On the other hand, the support 4 may be provided with a linear moving mechanism (not shown) instead of the linear moving mechanism 9.

Furthermore, when the winding face of the support 4 is a curved face having a large curvature, the extruder 5 is provided with a pivot moving mechanism (not shown) in addition to the linear moving mechanism 9. The pivot moving mechanism turns the top of the feeding port 5a along the winding curved face of the support 4.

Moreover, the production apparatus shown in FIG. 3 has a guide roller 10 ahead of the feeding port 5a of the extruder 5. The guide roller 10 guides the rubber member fed from the feeding port 5a to a given position of the winding face of the rotating support 4.

The following examples are given in illustration of the invention and are not intended as limitations thereof.

### EXAMPLE 1

A rubber composition A excluding a vulcanizing agent and a rubber composition B excluding a vulcanization accelerator are prepared according to a compounding recipe shown in Table 1. Then, the rubber composition A and the rubber composition B are separately extruded through extruders 2a and 2b in the apparatus shown in FIG. 2 and wound on a rotating support 1 to form uncured rubber members.

### COMPARATIVE EXAMPLE 1

The conventional rubber composition C is prepared according to the compounding recipe of Table 1. Then, it is extruded through a single extruder and wound on the rotating support 1 to form an uncured rubber member.

TABLE 1
(parts by weight)

| | Rubber | Rubber | Rubber |
|---|---|---|---|
| | composition A | composition B | composition C |
| SBR#1500 *1 | 100 | 100 | 100 |
| Carbon black (ISAF) | 50 | 50 | 50 |
| Process oil | 10 | 10 | 10 |
| Zinc oxide | 5 | 5 | 5 |
| TBBS (vulcanization | 2 | 0 | 1 |
| accelerator) *2 | | | |
| MBTS (vulcanization | 1 | 0 | 0.5 |
| accelerator) *3 | | | |
| Sulfur | 0 | 4 | 2 |
| Total | 168.0 | 169.0 | 168.5 |

Note:
*1 trade mark of styrene-butadiene rubber, made by JSR Corporation
*2 N-(t-butyl)-2-benzothiazole sulfenamide
*3 dibenzothazyl disulfide

In Example 1 is not observed the scorching at the shaping step of each rubber composition, while the scorching is observed at the shaping step of the rubber composition in Comparative Example 1. As a result, it is confirmed that the occurrence of the scorching can be prevented by the production method and production apparatus according to the invention.

### COMPARATIVE EXAMPLES 2-3, AND EXAMPLES 2-4

Rubber compositions X, Y, Z, W are prepared according to compounding recipes shown in Table 2, respectively, and used in a region corresponding to a tread portion or a side portion of a tire at a combination shown in Table 3 to produce an innerliner, from which is produced a side-reinforcement type run-flat tire having a tire size of PSR 245/40ZR18. Moreover, the innerliners of Comparative Examples 2 and 3 are produced by the conventional drum shaping with the rubber composition X or Z, while the innerliners of Examples 2-4 are produced by the apparatus shown in FIG. 3. With respect to these tires, the run-flat durability and air holding property are measured by the following methods to obtain results shown in Table 3.

The run-flat durability is evaluated by measuring a running distance until the occurrence of tire trouble when the test tire is run at a speed of 90 km/hr under conditions of a load of 6.23 kN and an internal pressure of 0 kPa, and represented by an index on the basis that the running distance of Comparative example 2 is 100. The larger the index value, the better the run-flat durability.

The air holding property is evaluated by measuring an internal tire pressure after the test tire inflated under an internal pressure of 230 kPa is left to stand at a temperature of a test chamber of 25±2° C. for 30 days, and represented by an index on the basis that the internal pressure holding ratio of Comparative example 2 is 100. The larger the index value, the better the air holding property.

TABLE 2
(parts by weight)

| | Rubber | Rubber | Rubber | Rubber |
|---|---|---|---|---|
| | composition | composition | composition | composition |
| | X | Y | Z | W |
| Natural rubber | 0 | 10 | 20 | 30 |
| Brominated | 100 | 90 | 80 | 70 |
| butyl rubber | | | | |
| Carbon black | 50 | 50 | 50 | 50 |
| (N660) | | | | |
| Process oil | 10 | 10 | 10 | 10 |
| Zinc white | 3 | 3 | 3 | 3 |
| Stearic acid | 2 | 2 | 2 | 2 |
| Sulfur | 1 | 1 | 1 | 1 |

TABLE 3

| | Com- | Com- | | | |
|---|---|---|---|---|---|
| | parative | parative | | | |
| | Exam- | Exam- | Exam- | Exam- | Exam- |
| | ple 2 | ple 3 | ple 2 | ple 3 | ple 4 |
| Rubber composition | X | Z | X | Y | Y |
| in tread portion | | | | | |
| corresponding region | | | | | |
| Gauge of tread portion | 1.0 | 1.0 | 1.0 | 1.0 | 1.0 |
| (mm) | | | | | |
| Rubber composition | X | Z | Z | W | W |
| in side portion | | | | | |
| corresponding region | | | | | |
| Gauge of side portion | 1.0 | 1.0 | 1.0 | 1.0 | 1.3 |
| (mm) | | | | | |
| Run-flat durability | 100 | 125 | 125 | 140 | 140 |
| Air holding property | 100 | 90 | 95 | 90 | 95 |

In Comparative Example 3, the diene rubber is mixed with the brominated butyl rubber in order to improve the run-flat durability of Comparative Example 2 corresponding to the conventional innerliner. Due to the mixing of the diene rubber, the air holding property largely lowers though the run-flat durability is improved.

Example 2 is a case that the diene rubber is compounded in only the side portion corresponding region as compared with Comparative Example 2. In this case, the run-flat durability is improved by the mixing of the diene rubber in the side portion corresponding region, while the lowering of the air holding property is slight because the rubber component in the tread portion corresponding region consists of only the brominated butyl rubber likewise Comparative Example 2.

Example 3 is a case that the ratios of diene rubber in the side portion corresponding region and the tread portion corresponding region are made higher than those of Example 2. The air holding property is equal to that of Comparative example 3, while the run-flat durability is further improved as compared with those of Comparative Example 3 and Example 2.

Example 4 is a case that the gauge of the side portion corresponding region is made 1.3 times larger than that of Example 3. In this case, the run-flat durability is very excellent likewise Example 3, while the air holding property is improved by thickening the side portion corresponding region. Also, the lowering of the air holding property is slight as compared with Comparative Example 2.

### INDUSTRIAL APPLICABILITY

In the production method of the uncured rubber member according to the invention, the uncured rubber composition to be shaped in the shaping machine is made of a compounding system excluding either the vulcanizing agent or vulcanization accelerator, so that the occurrence of the scorching resulted from heat generation due to the friction in the shaping can be prevented and the production efficiency in the shaping can be largely increased.

On the other hand, when the innerliner, characterized in that the rubber component for the innerliner contains at least 10% by mass of diene rubber in the region corresponding to the tire side portion and the ratio of diene rubber in the region corresponding to the tire tread portion is made lower than that in the side portion corresponding region, is applied to the tire, the run-flat durability can be largely improved while suppressing the lowering of the air holding property as compared with the tire using the conventional innerliner composed of only butyl rubber or halogenated butyl rubber.

Also, by adopting the production method of the tire according to the invention, characterized in that when the rubber compositions are separately taken out from plural storage tanks having different rubber compositions and kneaded and extruded through the extruder and the extrudate is wound on the rotating support to form an innerliner layer for the tire, the take-out amounts of the rubber compositions are changed so that the rubber component for the innerliner contains at least 10% by mass of diene rubber in the region corresponding to the tire side portion and the ratio of diene rubber in the region corresponding to the tire tread portion is made lower than that in the side portion corresponding region, it is easy to optionally change the ratio of diene rubber in the regions of the innerliner corresponding to the side portion and the tread portion and the manual operation is not required and hence the productivity is increased.

1. A method of producing an uncured rubber member, characterized in that a rubber composition A of a compounding system excluding a vulcanizing agent and a rubber composition B of a compounding system excluding a vulcanization accelerator are produced separately, and the rubber composition A and the rubber composition B are shaped into given forms through a shaping machine, respectively, and wound on a rotating support.

2. A method of producing an uncured rubber member according to claim 1, wherein the shaping machine is an extruder.

3. A method of producing an uncured rubber member according to claim 1, wherein the form of the rubber composition A and/or B after the shaping is any one of sheet, ribbon and string.

4. A method of producing an uncured rubber member according to claim 1, wherein the rubber composition A and/or B after the shaping is wound in a helical form.

5. A method of producing an uncured rubber member according to claim 1, wherein the rubber composition A and/or B after the shaping is cooled before the winding on the rotating support.

6. A method of producing an uncured rubber member according to claim 1, wherein an existing ratio of the rubber composition A and the rubber composition B in the uncured rubber member is properly changed.

7. A method of producing an uncured rubber member according to claim 1, wherein an existing ratio of the rubber composition A and the rubber composition B in the uncured rubber member is properly changed in a widthwise direction of the support.

8. An apparatus for producing an uncured rubber member, comprising a rotating support and plural extruders connecting to the support.

9. An apparatus for producing an uncured rubber member according to claim 8, wherein a cooling device is arranged between the extruder and the support.

10. A tire provided with an innerliner, characterized in that a rubber component for the innerliner contains at least 10% by mass of diene rubber in a region corresponding to a tire side portion and a ratio of diene rubber in a region corresponding to a tire tread portion is made lower than that in a side portion corresponding region.

11. A tire according to claim 10, wherein the rubber component for the inner-liner contains 10-40% by mass of diene rubber in the region corresponding to the side portion.

12. A tire according to claim 10, wherein the rubber component for the innerliner is composed mainly of halogenated butyl rubber and contains 90-60% by mass of halogenated butyl rubber and 10-40% by mass of diene rubber.

13. A tire according to claim 10, wherein the diene rubber is a natural rubber.

14. A tire according to claim 10, wherein a reinforcing rubber of substantially a crescent-shaped form in section is arranged an innerliner and a carcass ply in the tire side portion.

15. A tire according to claim 10, wherein a ratio of diene rubber in the rubber component for the innerliner is continuously changed from the side portion corresponding region to the tread portion corresponding region.

16. A method of producing a tire provided with an innerliner by separately taking out rubber compositions from plural storage tanks containing different rubber compositions and kneading and extruding through an extruder and winding the resulting extrudate on a rotating support to form an innerliner layer, characterized in that take-out amounts of the rubber compositions are changed so that a rubber component for the innerliner contains at least 10% by mass of diene rubber in a region corresponding to a tire side portion and a ratio of diene rubber in a region corresponding to a tire tread portion is made lower than that in a side portion corresponding region.

17. A method of producing a tire according to claim 16, wherein the take-out amount is continuously changed.

18. A method of producing a tire according to claim 16, wherein the rotating support is a rigid core having an outer surface form substantially corresponding to an inner surface form of a product tire.
